(19) United States
(12) Patent Application Publication
(10) Pub. No.: US 2026/0255413 A1
(43) Pub. Date: Aug. 27, 2026

(54) METHODS AND APPARATUS FOR MODEL TRANSFER/DELIVERY FOR WIRELESS COMMUNICATION SYSTEMS

(71) Applicant: MEDIATEK SINGAPORE PTE. LTD., Singapore (SG)

(72) Inventors: Xiaonan ZHANG, Beijing (CN); Yuanyuan ZHANG, Beijing (CN); Hao BI, San Jose, CA (US)

(73) Assignee: MEDIATEK SINGAPORE PTE. LTD., Singapore (SG)

(21) Appl. No.: 19/475,724

(22) PCT Filed: Sep. 18, 2024
(86) PCT No.: PCT/CN2024/119404

§ 371 Date: Oct. 15, 2025

(30) Foreign Application Priority Data
Nov. 13, 2023 (WO) PCT/CN2023/131322

(51) Int. Cl. H04W 76/12; H04L 41/16; H04W 24/02; H04W 24/10

(52) U.S. Cl. CPC H04W 76/12; H04L 41/16; H04W 24/02; H04W 24/10

(57) ABSTRACT

Apparatus and methods are provided for model transfer/delivery in the wireless network. In one novel aspect, the model transfer procedure includes triggering the model transfer/delivery procedure and establishing model transferring tunnel. In one embodiment, the sending of the model transfer request is triggered upon detecting one or more conditions by the UE, and wherein the one or more conditions comprising: one or more changes in site, one or more changes in scenario or one or more changes in radio environment. In another embodiment, the sending of the model transfer request is triggered by receiving a model transfer indication from the RAN node. In one embodiment, the model transfer request is delivered to the RAN or a CN entity through a control plane (CP) signaling or a user plane (UP). In another embodiment, the model transfer request is delivered directly to the UE server by dataflow.

### CROSS REFERENCE TO RELATED APPLICATIONS

This application is filed under 35 U.S.C. § 111(a) and is based on and hereby claims priority under 35 U.S.C. § 120 and § 365(c) from International Application No. PCT/CN2023/131322, titled “Method and apparatus for AI/ML model transfer/delivery for wireless communication systems,” filed on Nov. 13, 2023. The disclosure of the foregoing documents is incorporated herein by reference.

### TECHNICAL FIELD

The disclosed embodiments relate generally to wireless communication, and, more particularly, to model transfer.

### BACKGROUND

With the rapid development in wireless communication, the more efficient procedures are required, such as channel state information (CSI) feedback, beam measurement, positioning, and mobility procedures in 5G and future 6G. In the conventional network of the 3rd generation partnership project (3GPP) 5G new radio (NR), new technology is leveraged to address challenges due to the increased complexity of foreseen deployments over the air interface, both for the network and UEs. How to successfully perform model transfer/delivery to the UE for the promising advanced technology is an important aspect for its usage in the wireless network.

Apparatus and mechanisms are sought to perform model transfer/delivery for wireless communication systems.

### SUMMARY

Apparatus and methods are provided for model transfer/delivery in the wireless network. In one novel aspect, the model transfer procedure includes triggering the model transfer/delivery procedure and establishing model transferring tunnel. In one embodiment, the sending of the model transfer request is triggered upon detecting one or more conditions by the UE, and wherein the one or more conditions comprising: one or more changes in site, one or more changes in scenario or one or more changes in radio environment. In another embodiment, the sending of the model transfer request is triggered by receiving a model transfer indication from the RAN node. In one embodiment, the model transfer request is delivered to the RAN or a CN entity through a control plane (CP) signaling or a user plane (UP). In one embodiment, the model transfer request is delivered to the RAN using a minimization of drive test (MDT), or a self-organizing network (SON) or a measurement report. In another embodiment, the model transfer request is delivered directly to the UE server by dataflow.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary wireless network that supports AI-ML model transfer/delivery in accordance with embodiments of the current invention.

FIG. 2 illustrates diagrams for an exemplary process of the AI-ML model transfer/delivery in accordance with embodiments of the current invention.

FIG. 3 illustrates exemplary diagrams of model transfer triggering initiate by UE in accordance with embodiments of the current invention.

FIG. 4 illustrates exemplary diagrams of model transfer triggering initiate by OTT server in accordance with embodiments of the current invention.

FIG. 5 illustrates an exemplary flow of data collection without RAN awareness triggering from the UE server to the CN entity and from the UE server to UE in accordance with embodiments of the current invention.

FIG. 6 illustrates FIG. 6 illustrates exemplary diagrams of model transfer/delivery tunnel in accordance with embodiments of the current invention.

FIG. 7 illustrates an exemplary overall flow to perform model transfer/delivery triggering and model transfer/delivery procedure in accordance with embodiments of the current invention.

FIG. 8 illustrates an example message diagram of a two-step AI-ML model delivery through the RAN node in accordance with embodiments of the current invention.

FIG. 9 illustrates an example message diagram of a two-step AI-ML model delivery through the CN entity in accordance with embodiments of the current invention.

FIG. 10 illustrates an example flow chart of the UE performing the AI-ML model transfer/delivery in accordance with embodiments of the current invention.

FIG. 11 illustrates an example flow chart of the RAN node performing the AI-ML model transfer/delivery in accordance with embodiments of the current invention.

### DETAILED DESCRIPTION

Reference will now be made in detail to some embodiments of the invention, examples of which are illustrated in the accompanying drawings.

Several aspects of telecommunication systems will now be presented with reference to various apparatus and methods. These apparatus and methods will be described in the following detailed description and illustrated in the accompanying drawings by various blocks, components, circuits, processes, algorithms, etc. (Collectively referred to as “elements”). These elements may be implemented using electronic hardware, computer software, or any combination thereof. Whether such elements are implemented as hardware or software depends upon the particular application and design constraints imposed on the overall system.

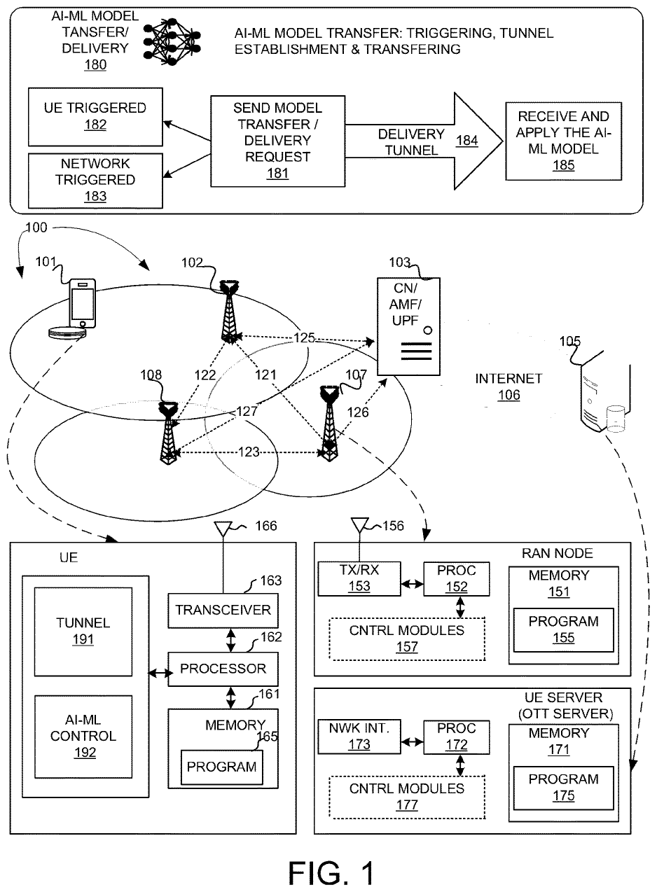

FIG. 1 is a schematic system diagram illustrating an exemplary wireless network that supports AI-ML model transfer/delivery in accordance with embodiments of the current invention. Wireless communication network 100 includes one or more fixed base infrastructure units forming a network distributed over a geographical region. The base unit may also be referred to as an access point, an access terminal, a base station, a Node-B, an eNode-B (eNB), a gNB, or by other terminology used in the art. As an example, base stations serve a number of mobile stations within a serving area, for example, a cell, or within a cell sector. In some systems, one or more base stations are coupled to a controller forming an access network that is coupled to one or more core networks. gNB 102, gNB 107 and gNB 108 are base stations in the wireless network, the serving area of which may or may not overlap with each other. gNB 102 is connected with gNB 107 via Xn interface 121. gNB 102 is connected with gNB 108 via Xn interface 122. gNB 107 is connected with gNB 108 via Xn interface 123. Core network (CN) entity 103 connects with gNB 102 and 107, through NG interface 125 and 126, respectively. Network entity CN 109 connects with gNB 108 via NG connection 127. Exemplary CN 103 and CN 109 connect to model server 105 through internet 106. CN 103 and CN 109 includes core components such as user plane function (UPF) and access and mobility management function (AMF). In one embodiment, model server 105 is a UE server. According to some examples, the UE server can be inside of a mobile network operator (MNO). According to some other examples, the UE server can be outside of the MNO, and it can be also referred to as an over-the-top (OTT) server. Please note that some of the following examples are described in the context of OTT server, but they can also be applied to other types of UE server.

FIG. 1 further illustrates general AI-ML model transfer/delivery framework for the UE(s), the RAN nodes/gNB(s), the CN, and the UE server, such as an OTT server, respectively. CN 103 is the backbone of the wireless network and communicates with the UE server via internet 106. In one embodiment, CN 103 includes the network node/entity/function, such as access management function (AMF)/user plane function (UPF), core network (CN), operations, administration, and maintenance (OAM), etc.

In the development of AI-ML algorithms for wireless technology, it is important to tailor them to specific scenarios, locations, configurations, and deployments. This customization allows for better performance, as a one-size-fits-all approach may not be optimal. AI-ML algorithms can be updated through model changes, indicating the need for flexibility and adaptability in the application of AI-ML models. When AI models are designed for specific scenarios, configurations, or sites, they can be selected or activated for inference when applicable. Model transfer/delivery is the process that enables the availability of an AI-ML model at the UE side. It becomes necessary when there is no existing AI-ML model at the UE that is applicable to the relevant scenario, configuration, or site. The term ‘scenarios’ could signify a range of conditions, including various deployment scenarios, different distributions of outdoor or indoor UE, a variety of UE mobility levels, or a range of carrier frequencies. Other aspects of scenarios are not excluded. Configurations might stand for parameters such as different UE settings, an assortment of gNB settings, a variety of bandwidths (like 10 MHz, 20 MHz), diverse antenna port layouts (for instance, N1/N2/P) or different numbers of antenna ports (such as 32-port, 16-port), etc. Various use cases might emphasize different elements of the scenarios and configurations. In such instances, the UE needs to download the AI-ML model trained for the specific scenario, configuration, or site.

In one novel aspect 180, UE performs AI-ML model transfer/delivery. At step 181, an AI-ML model transfer request is sent. In one embodiment 182, the sending of the AI-ML model transfer request is triggered by the UE. In another embodiment 183, the sending of the AI-ML model transfer request is triggered by the RAN node. At step 184, the UE establishes a data delivery tunnel for the AI-ML transfer/delivery. At step 185, the UE receives and applies the AI-ML model.

FIG. 1 further illustrates simplified block diagrams of a RAN node/base station, a UE server and a mobile device/UE that supports data collection. The gNB/RAN node has an antenna 156, which transmits and receives radio signals. An RF transceiver circuit 153, coupled with the antenna 156, receives RF signals from antenna 156, converts them to baseband signals, and sends them to processor 152. RF transceiver 153 also converts received baseband signals from processor 152, converts them to RF signals, and sends out to antenna 156. Processor 152 processes the received baseband signals and invokes different functional modules to perform features in gNB 107. Memory 151 stores program instructions and data 155 to control the operations of the base station/gNB. The base station/gNB also includes a set of control modules 157 that carry out functional tasks to communicate with mobile stations. These control modules can be implemented by circuits, software, firmware, or a combination of them.

FIG. 1 also includes simplified block diagrams of a UE, such as UE 101. The UE may also be referred to as a mobile station, a mobile terminal, a mobile phone, a smart phone, a wearable device, an IoT device, a tablet, a laptop, or other terminology used in the art. The UE performs functions perform AI-ML model transfer/delivery. UE interacts with gNB through the air interface. The UE has an antenna 166, which transmits and receives radio signals. An RF transceiver circuit 163, coupled with the antenna, receives RF signals from antenna 166, converts them to baseband signals, and sends them to processor 162. RF transceiver 163 also converts received baseband signals from processor 162, converts them to RF signals, and sends out to antenna 166. Processor 162 processes the received baseband signals and invokes different functional modules to perform features in UE 101. Memory 161 stores program instructions and data 165 to control the operations of UE 101. Antenna 166 sends uplink transmission and receives downlink transmissions to/from antenna 156 of the base station/gNB.

The UE also includes a set of control modules that carry out functional tasks. These control modules can be implemented by circuits, software, firmware, or a combination of them. A tunnel module 191 establishes an artificial intelligence-machine learning (AI-ML) model transfer tunnel with a model server in the wireless network, wherein the model server is a UE server, a core network (CN) entity, or a radio access network (RAN) node. An AI-ML control module 192 receives an AI-ML model through the AI-ML model transfer tunnel.

FIG. 1 also includes simplified block diagrams of an UE server, such as UE server 105. The UE server has a network interface module 173, which transmits and receives signals/message through the network. Processor 172 processes the received messages and invokes different functional modules to perform features in the UE server. Memory 171 stores program instructions and data 175 to control the operations of the UE server. The UE server also includes a set of control modules 177 that carry out functional tasks to communicate with mobile stations. These control modules can be implemented by circuits, software, firmware, or a combination of them.

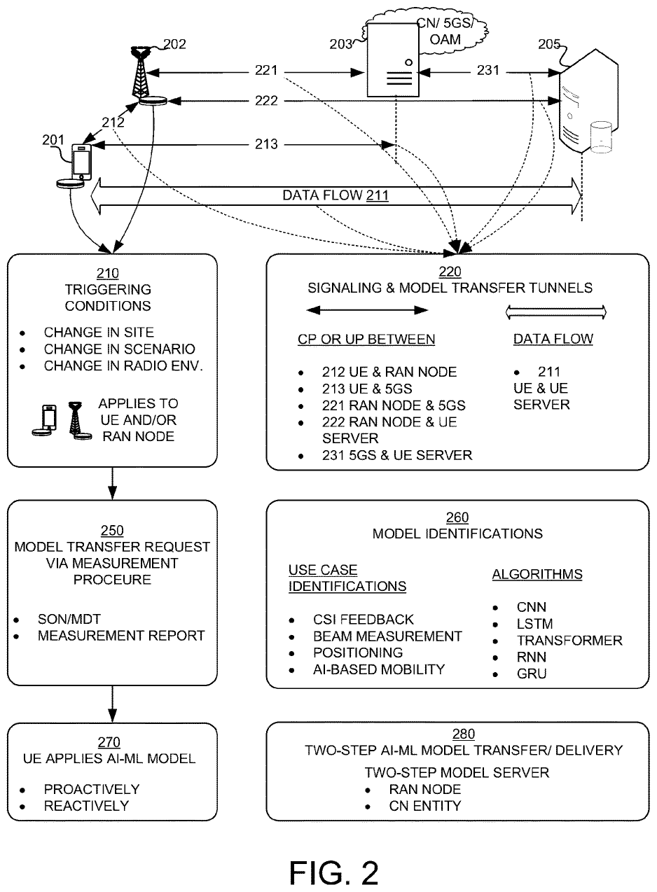

FIG. 2 illustrates diagrams for an exemplary process of the AI-ML model transfer/delivery in accordance with embodiments of the current invention. One or more UEs, such as UEs 201, connect with a RAN node/gNB 202. gNB 202 connects with the core network 203. Core network 203 includes network functions and/or entities, such as AMF/UPF, OAM and other network functions/entities. Core network 203 connects with an UE server 205. The dataflow is between UE server 205 and UE 201. In other embodiments, multiple CP (control plane)/UP (user plane) tunnels may be used for the model transfer/delivery and signaling. The overall procedure may contain model transfer/delivery triggering 210 (i.e., request to the UE server for model transfer/delivery from UE, RAN or initiate by OTT server itself), setup model transfer/delivery tunnel 220 (from OTT server to UE), further contains the signaling over interface on Uu, Xn, NG, etc. model transfer/delivery procedure, to delivery/transfer updated model from UE server 205 to UE 201. In one embodiment 210, the sending of the model transfer request is triggered upon detecting one or more conditions by the UE, and wherein the one or more conditions comprising: one or more changes in site, one or more changes in scenario or one or more changes in radio environment. The conditions apply to UE and/or the RAN node. In one embodiment 220, the UE establishes AI-ML model transfer tunnel. The AI-ML model transfer tunnel is used for signaling and/or AI-ML model data transferring. The signaling tunnel and the data transferring data may be the same tunnel or different. In one embodiment, signaling and/or the AI-ML model transfer tunnel 211 is between the UE and the UE server. Tunnel 211 is a data flow tunnel. UE 201 may establish a tunnel with multiple connections, including one or more CP or UP tunnels, such as tunnel 212, 213, 221, 222, and 231. For example, the signaling or model transfer data tunnel includes a CP or UP tunnel 212 between UE 201 and RAN node 202 and a CP or UP tunnel 222 between RAN node 202 and UE server 205. Similarly, the signaling or model transfer data tunnel between UE 201 and UE server 205 may include a UE-RAN node CP or UP tunnel 212 between UE 201 and RAN node 202, a UE-CN CP or UP tunnel 213 between UE 201 and a CN entity 203.

In one embodiment 250, the model transfer request from the UE is performed using the measurement procedure. For example, the model transfer request is sent using a minimization of drive test (MDT) of a self-organizing network (SON) or a measurement report procedure. In one embodiment 260, the UE further request model identification information. The model identifications include one or more use-case identification and/or an algorithm identification. The use case identifications include CSI feedback, bema measurement, positioning, AI-based mobility, and et al. The algorithm identification includes Convolutional Neural Networks (CNN), Long Short-Term Memory (LSTM), Transformer, Recurrent Neural Networks (RNN), Gated Recurrent Unit (GRU), and et al. In one embodiment 270, the UE applies the AI-ML model or the received AI-ML model update. In one embodiment, the AI-ML model is updated proactively for further use. In another embodiment, the AI-ML model is updated reactively for the current use. In one embodiment 280, the AI-ML model transfer/delivery is a two-step procedure. The two-step model sever is either a RAN node or a CN entity. The AI-ML model or the updated AI-ML model is pre-downloaded by the RAN node or the CN entity.

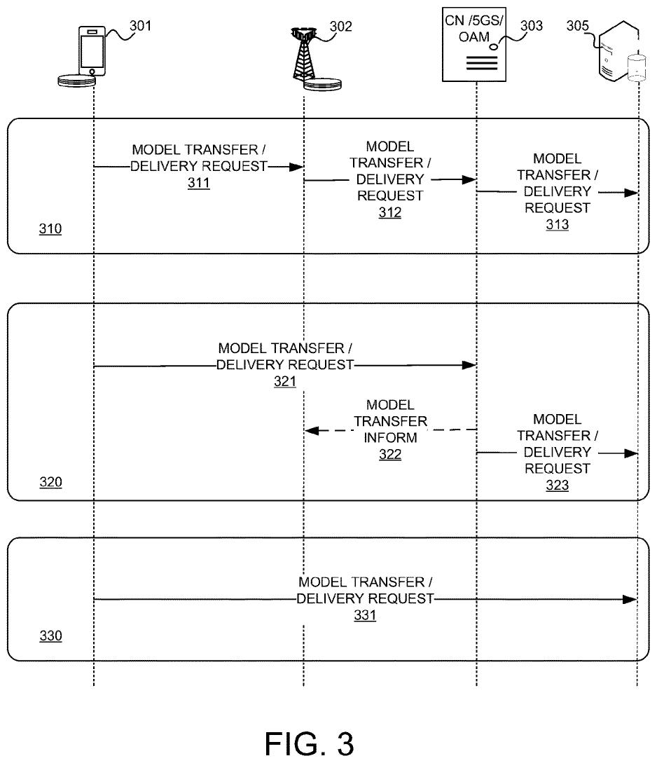

FIG. 3 illustrates exemplary diagrams of model transfer triggering initiate by UE in accordance with embodiments of the current invention. In one embodiment, the data collection triggering/request is from the UE server to UE through the application layer. UE 301 connects with RAN node 302 and CN 303, which connects with UE server 305. The UE detects the site, scenario or radio environment change, and the model transfer/delivery triggering is initiated from UE 301 to its UE server 305. In one embodiment, UE server 305 further sends a model transfer/delivery indication to UE 301, to the RAN node 302, or to a network entity 303 after receiving the model transfer/delivery request from UE 301. In these steps, the delivery tunnel can be CP/UP tunnel.

In one embodiment 310, the model transfer/delivery request is delivered from UE 301 to RAN node 302 (step 311), then further delivered to 5GS/OAM 303 (step 312), and then further delivered to UE server 305 (step 313). In these steps, the delivery tunnel can be CP/UP tunnel. In one embodiment, the model transfer/delivery request from UE is delivered via legacy measurement procedure (e.g., SON/MDT, UE measurement report). In one embodiment, the model transfer/delivery request from UE to RAN is delivered through RRC/MAC/PHY signaling.

In one embodiment 320, the model transfer/delivery request is delivered from UE 301 to 5GS/OAM 303 (step 321), and further delivered to UE server 305 (step 323). In these steps, the delivery tunnel can be CP/UP tunnel. In one embodiment, shown in step 322, 5GS/OAM 303 further indicates to RAN node 302 for the model transfer/delivery preparation (e.g., to set up model transfer/delivery tunnel).

In one embodiment 330, the model transfer/delivery request is delivered from UE 301 to UE server 305 via dataflow (step 331). In this case, the model transfer/delivery request may be performed without RAN/5GC/OAM awareness.

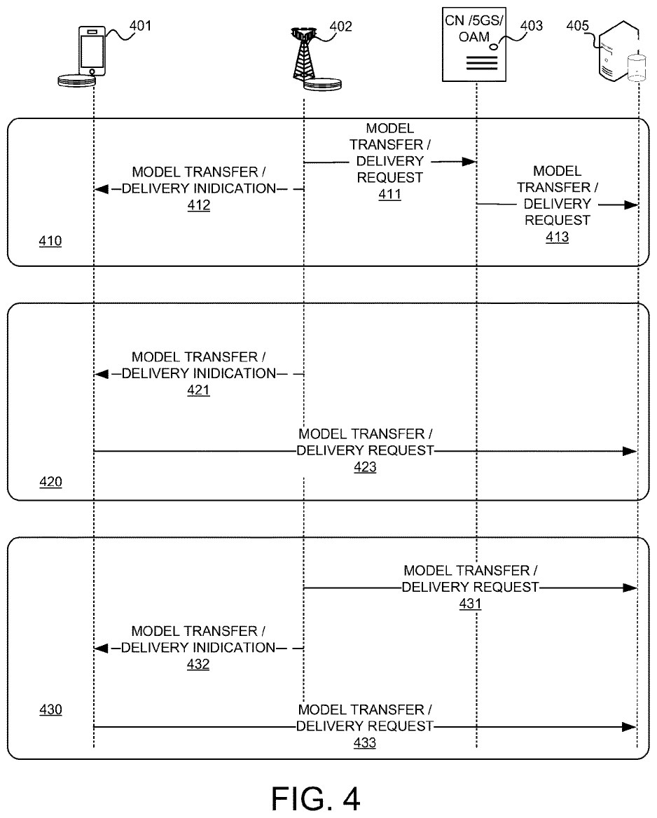

FIG. 4 illustrates exemplary diagrams of model transfer triggering initiate by RAN node in accordance with embodiments of the current invention. In one embodiment, the RAN node detects the UE, which is connected to itself changes the site, scenario or radio environment, or the RAN node changes the configuration, then the model transfer triggering is initiated from the RAN node to UE's UE server. In one embodiment, the UE server further sends a model transfer/delivery indication to the UE and/or to the network for the confirmation. UE 401 connects with a RAN node 402 to one or more CN entities 403, which connects with UE server 405. In one embodiment, the CN entity is a network node/entity/function (e.g., DCAF, CN, OAM, etc.) In one embodiment 410, at step 411, the model transfer/delivery request is delivered from RAN node 402 to 5GS/OAM 403, then further delivered to UE server 405 (step 413). In these steps, the delivery tunnel can be CP/UP tunnel. In one embodiment, at step 412, RAN node 402 further indicates UE 401 for the model transfer/delivery preparation (e.g., to setup model transfer/delivery tunnel). In one embodiment 420, RAN node 402, at step 421, notifies UE 401 with the model transfer/delivery indication. At step 423, UE 401 further requests a model transfer/delivery to its UE server 405. In one embodiment, this transfer/delivery request from UE 401 to UE server 405 is delivered via dataflow. In another embodiment 430, at step 431, the model transfer/delivery request is delivered from RAN node 402 to UE server 405 via CP or UP tunnel. In one embodiment, at step 432, RAN node 402 further sends model transfer/delivery indication to UE 401 for the model transfer/delivery preparation. In one embodiment, at step 433, UE 401 further requests a model transfer/delivery to its UE server 405 after receiving the indication from RAN node 402. In one embodiment, UE server 405 further sends a model transfer/delivery indication to UE 401 after receiving the request from RAN node 402.

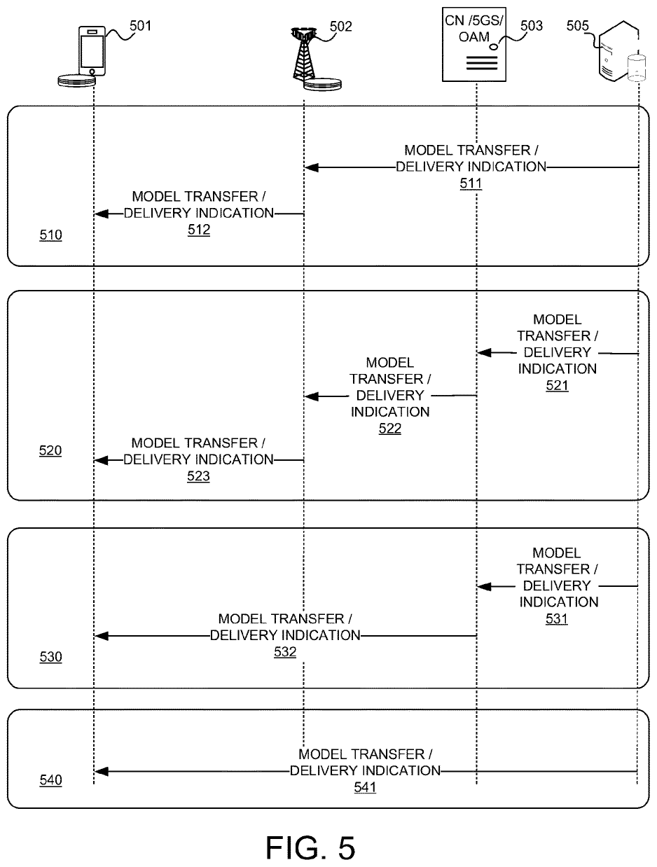

FIG. 5 illustrates exemplary diagrams of model transfer triggering initiate by UE server in accordance with embodiments of the current invention. In one embodiment, the UE server updates the model for one scenario and initializes the model transfer procedure proactively by itself, then the UE server sends model transfer/delivery indication to UE and/or the network. UE 501 connects with RAN node 502 and CN entity 503, which connects with UE server 505. In one embodiment 510, the model transfer/delivery indication is delivered from UE server 505 to RAN node 502 (step 511), then further delivered to UE 501 (512). In one embodiment 520, the model transfer/delivery indication is delivered from UE server 505 to CN entity 503 (step 521). At step 522, CN entity delivers the model transfer/delivery indication to RAN node 502. At step 523, RAN node 502 delivers the model transfer/delivery indication to UE 501. In one embodiment 530, the model transfer/delivery indication is delivered from UE server 505 to CN entity 503 (step 531). At step 532, CN entity 503 delivers model transfer/delivery indication to UE 501. In these steps in 510, 520, and 530, the delivery tunnel can be CP/UP tunnel. In one embodiment 540, at step 541, the model transfer/delivery indication is delivered from UE server 505 to UE 501 via dataflow. In this case, the model transfer/delivery indication may be delivered without RAN/CN entity awareness. In one embodiment, the application layer of UE informs the request to RRC layer, then the UE sends model transfer/delivery request to RAN/CN entity.

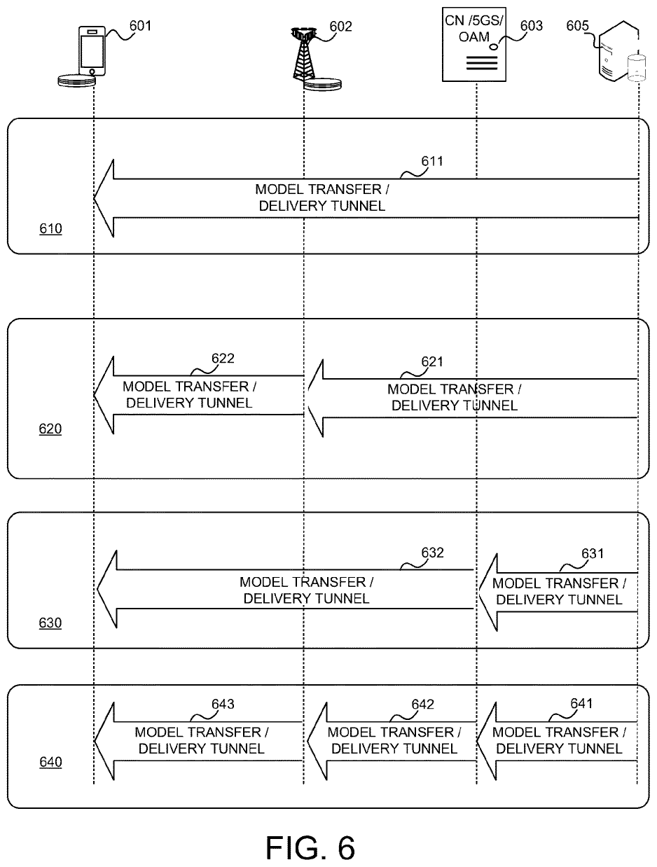

FIG. 6 illustrates exemplary diagrams of model transfer/delivery tunnel in accordance with embodiments of the current invention. The model transfer/delivery tunnel is setup after model transfer/delivery triggering initiated by the UE, the RAN node, and/or the UE server. UE 601 connects with RAN node 602 and CN entity 603, which connects with UE server 605. In one embodiment 610, the model transfer/delivery tunnel is from UE server 605 to UE 601 via dataflow tunnel 611. In this case, the model transfer/delivery may be performed without RAN and/or CN awareness. In one embodiment 620, the model transfer/delivery tunnel is tunnel 621 from UE server 605 to RAN node 602, then tunnel 622 from RAN node 602 to UE 601. In one embodiment 630, the model transfer/delivery tunnel is tunnel 631 from UE server 605 to CN 603, then tunnel 632 from CN 603 to UE 601. In one embodiment 640, the model transfer/delivery tunnel is tunnel 641 from UE server 605 to CN 603, then tunnel 642 from CN 603 to RAN node 602, then tunnel 643 from RAN node 602 to UE 601. In these steps in 620, 630, and 640, the model transfer/delivery tunnel can be CP/UP tunnel.

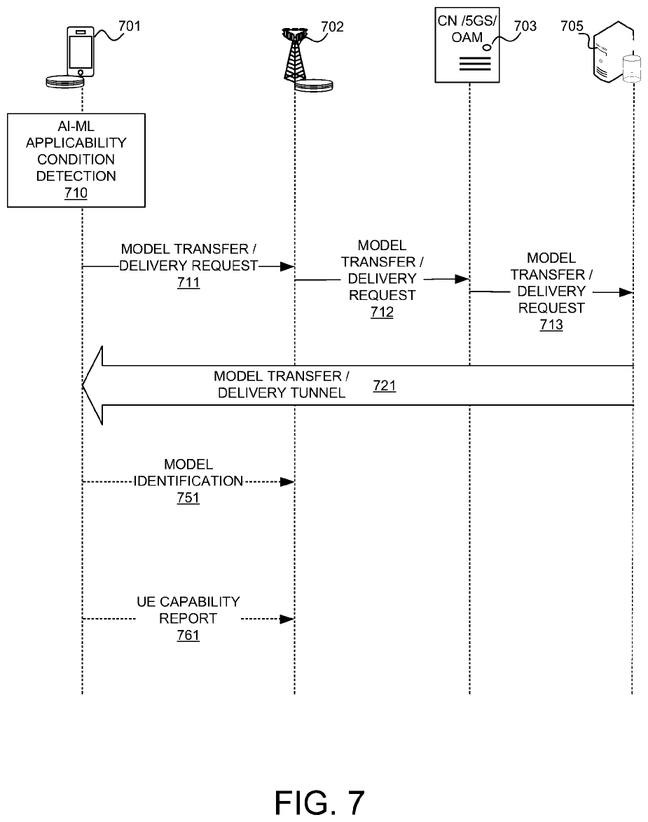

FIG. 7 illustrates an exemplary overall flow to perform model transfer/delivery triggering and model transfer/delivery procedure in accordance with embodiments of the current invention. UE 701 connects with RAN node 702 and CN entity 703, which connects with UE server 705. At step 710, UE 701 detects one or more site, scenario or radio environment changes. At step 711, the model transfer/delivery triggering is initiated, and UE 701 sends model transfer/delivery request destined to UE server 705. The model transfer/delivery request is delivered from UE 701 to RAN node 702 (step 711), then further delivered to CN 703 (step 712), and then further delivered to UE server 705 (step 713). In other embodiments, other model transfer/delivery triggering as described in FIG. 3, FIG. 4 and FIG. 5 can be used. Model transfer/delivery procedure is performed from UE server 705 to UE 701 via model transfer/delivery tunnel. In one embodiment, the model transfer/delivery tunnel is from the UE server to UE via dataflow (721). In other embodiments, other forms of transfer/delivery tunnel as described in FIG. 6 is used.

In one embodiment, UE 701 receives the updated model from UE server 705 via model transfer/delivery tunnel. After receiving the updated model, at step 751, UE 701 further requests model identification to network, such as RAN node 702 or CN 703. In one embodiment, at step 761, UE 701 further reports the updated UE capability for the updated model to the network, such as to RAN node 702 and/or CN 703.

In one embodiment, the model transfer/delivery is a two-step procedure. In the first step, the model transfer preparation can be initiated from UE, RAN or UE server, and the model is transferred to RAN node or 5GS for model transfer preparation. The model transfer/delivery tunnel can be CP/UP tunnel from UE server to RAN/5GS. In one embodiment, the model is stored in RAN node or 5GS for further model transfer triggering. In the second step, the model transfer triggering is initiated from UE, RAN or UE server, and the model is further transferred from RAN/5GS to UE. The model transfer/delivery tunnel can be CP/UP tunnel from RAN/5GS to UE.

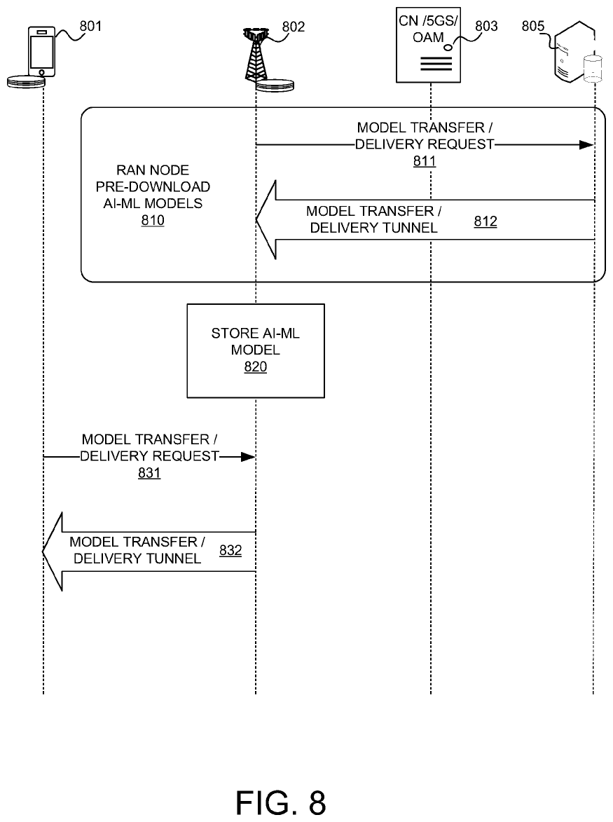

FIG. 8 illustrates an example message diagram of a two-step AI-ML model delivery through the RAN node in accordance with embodiments of the current invention. UE 801 connects with RAN node 802 and CN entity 803, which connects with UE server 805. In one embodiment 810, the RAN node pre-downloaded one or more AI-ML models and stores the downloaded one or more AI-ML models. The RAN node delivers the one or more pre-downloaded AI-ML models to one or more corresponding UEs, such as UE 801. At step 811, RAN node 802 sends model transfer/delivery request to UE server 805. At step 812, UE server 805 sends the AI-ML model or updated AI-ML model to RAN node 802. At step 820, RAN node 802 stores the downloaded AI-ML model. At step 831, UE 801 sends model transfer/delivery request to RAN node 802. At step 832, RAN node 802 sends the AI-ML model requested by UE 801 to UE 801 through an established AI-ML model transfer tunnel. In one embodiment, the RAN node pre-downloading of the AI-ML model procedure 810 is triggered by receiving a notification from UE server 805 for the pre-download.

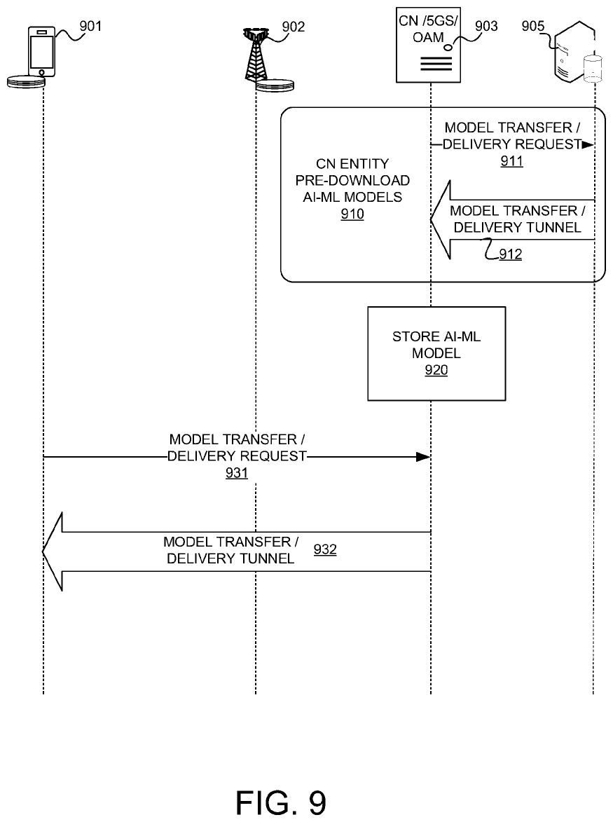

FIG. 9 illustrates an example message diagram of a two-step AI-ML model delivery through the CN entity in accordance with embodiments of the current invention. UE 901 connects with RAN node 902 and CN entity 903, which connects with UE server 905. In one embodiment 910, the CN node pre-downloaded one or more AI-ML models and stores the downloaded one or more AI-ML models. The CN node delivers one or more pre-downloaded AI-ML models to one or more corresponding UEs, such as UE 901. At step 911, CN node/entity 903 sends model transfer/delivery request to UE server 905. At step 912, UE server 905 sends the AI-ML model or updated AI-ML model to CN node/entity 903. At step 920, CN node/entity stores the downloaded AI-ML model. At step 931, UE 901 sends model transfer/delivery request to CN node/entity 903. At step 932, CN node/entity 903 sends the AI-ML model requested by UE 901 to UE 901 through an established AI-ML model transfer tunnel. In one embodiment, CN entity 903 pre-downloading of the AI-ML model procedure 910 is triggered by receiving a notification from UE server 905 for the pre-download.

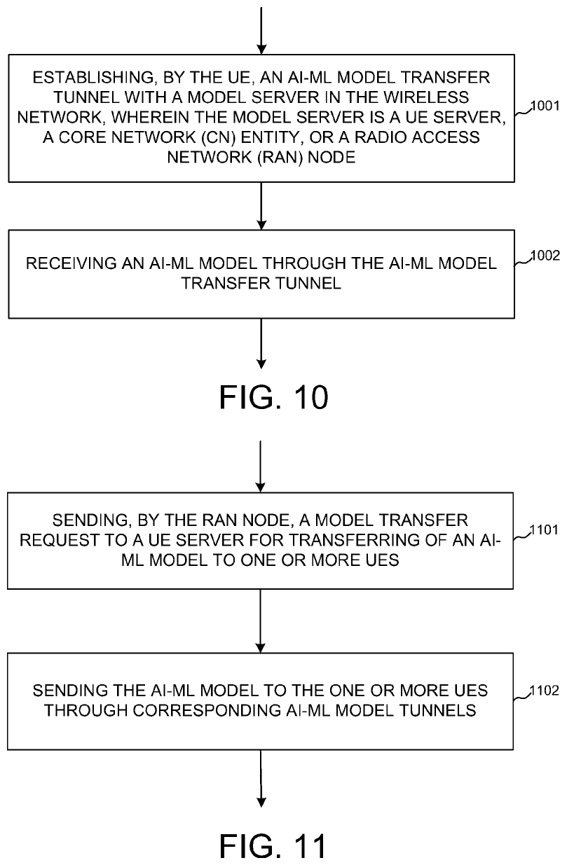

FIG. 10 illustrates an example flow chart of the UE performing the AI-ML model transfer/delivery in accordance with embodiments of the current invention. At step 1001, the UE establishes an AI-ML model transfer tunnel with a model server in the wireless network, wherein the model server is a UE server, a core network (CN) entity, or a radio access network (RAN) node. At step 1002, the UE receives an AI-ML model through the AI-ML model transfer tunnel.

FIG. 11 illustrates an example flow chart of the RAN node performing the AI-ML model transfer/delivery in accordance with embodiments of the current invention. At step 1101, the RAN node sends a model transfer request to a UE server for transferring of an AI-ML model to one or more UEs. At step 1102, the RAN node sends the AI-ML model to the one or more UEs through corresponding AI-ML model tunnels.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method for a user equipment (UE) using artificial intelligence-machine learning (AI-ML) model in a wireless network comprising:
establishing, by the UE, an AI-ML model transfer tunnel with a model server in the wireless network, wherein the model server is a UE server, a core network (CN) entity, or a radio access network (RAN) node; and
receiving an AI-ML model through the AI-ML model transfer tunnel.

2. The method of claim 1, wherein the model server is a UE server, and the method further comprising: sending a model transfer request by the UE to the UE server for the establishing of the AI-ML model transfer tunnel.

3. The method of claim 2, wherein the sending of the model transfer request is triggered upon detecting one or more conditions by the UE, and wherein the one or more conditions comprising: one or more changes in site, one or more changes in scenario or one or more changes in radio environment.

4. The method of claim 2, wherein the sending of the model transfer request is triggered by receiving a model transfer indication from the RAN node.

5. The method of claim 2, wherein the model transfer request is delivered to the RAN node or a CN entity through a control plane (CP) signaling or a user plane (UP).

6. The method of claim 5, wherein the model transfer request is delivered to the RAN node using a minimization of drive test (MDT), a self-organizing network (SON) or a measurement report.

7. The method of claim 2, wherein the model transfer request is delivered directly to the UE server by dataflow.

8. The method of claim 1, wherein the model server is the RAN node or the CN entity, and wherein the AI-ML model is pre-downloaded from the UE server to the RAN node or the CN entity respectively.

9. The method of claim 1, wherein the AI-ML model transfer tunnel is a dataflow tunnel between the UE and the UE server.

10. The method of claim 1, wherein the AI-ML model transfer tunnel includes a UE-RAN node tunnel between the UE and the RAN node, and wherein the UE-RAN node tunnel is a CP tunnel or a UP tunnel, or a UE-CN tunnel between the UE and the CN entity, and wherein the UE-CN tunnel is a CP tunnel or a UP tunnel.

11. The method of claim 1, further comprising:
obtaining one or more model identifications, wherein the one or more model identifications include one or more of use-case identification, and an algorithm identification.

12. The method of claim 11, further comprising:
requesting, from the wireless network, one or more model identifications after receiving the AI-ML model.

13. The method of claim 1, further comprising:
applying the received AI-ML model, wherein the AI-ML model is updated proactively for a further use or the AI-ML model is updated reactively for a current use.

14. The method of claim 1, further comprising:
reporting an updated UE capability based on the received AI-ML model to the wireless network.

15. A method for a radio access network (RAN) node providing artificial intelligence-machine learning (AI-ML) model for one or more UEs in a wireless network comprising:
sending, by the RAN node, a model transfer request to a UE server for transferring of an AI-ML model to one or more UEs; and
sending the AI-ML model to the one or more UEs through corresponding AI-ML model tunnels.

16. The method of claim 15, wherein the sending of the model transfer request is triggered by receiving an AI-ML model transfer request from at least one UE.

17. The method of claim 15, wherein the sending of the model transfer request is triggered by the RAN node detecting one or more triggering conditions, and wherein the one or more triggering conditions detected by the RAN node comprising: one or more changes in site, one or more changes in scenario, or one or more changes in radio environment.

18. The method of claim 15, further comprising: downloading and storing the AI-ML model from the UE server before the sending of the model transfer request to the UE server.

19. The method of claim 18, wherein the downloading of the AI-ML model is triggered by receiving a notification from the UE server to download the AI-ML model.

20. A user equipment (UE), comprising:
a transceiver that transmits and receives radio frequency (RF) signal in a wireless network;
a tunnel module that establishes an artificial intelligence-machine learning (AI-ML) model transfer tunnel with a model server in the wireless network, wherein the model server is a UE server, a core network (CN) entity, or a radio access network (RAN) node; and
an AI-ML control module that receives an AI-ML model through the AI-ML model transfer tunnel.
